(19) United States
(12) Patent Application Publication
(10) Pub. No.: US 2012/0047698 A1
(43) Pub. Date: Mar. 1, 2012

(54) Front to back reversible multiple planar paper clip with double clipping effect

(76) Inventor: Todd Michael O'Daniel, Thousand Oaks, CA (US)

(21) Appl. No.: 12/807,209

(22) Filed: Aug. 31, 2010

(51) Int. Cl. B42F 1/08

(52) U.S. Cl. 24/67 R

(57) ABSTRACT

One embodiment of a strong holding, overlapping, reversible front side to back side paper clip for securing a plurality of papers is of the type having two spline portions (12, 14) which communicate two end portions (16, 18), respectively, with a middle portion (10) (FIG. 1A, FIG. 1B, FIG. 3A-FIG. 3G). An operator holds a middle portion (10) as a tongue against one side of at least one sheet of paper or like sheet material and urges the end portions (16, 18) to the other side of the sheet material with a finger or the like, providing a primary clipping effect (FIG. 3A). An operator may move the end portions (16, 18) to an opposite front to back side of an embodiment to find a stronger holding side if and when deformation is present (FIG. 1B, FIG. 3D). An operator may move only one end portion, for example the end portion (18) to a back side, and use only one end portion (16) to hold sheet material on a front side (FIG. 3F, FIG. 3G). Also, with one end portion (18) on a back side, two documents may be held separately (FIG. 3G). One document may be held on the front side with a spline portion (12) and an end portion (16), and another document held on the back side with a spline portion (14) and an end portion (18) (FIG. 3G). Spacing apart of end portions (16, 18) laterally, is to facilitate movement of each end portion to an opposite front or back side of a middle portion (FIG. 1A). Other embodiments are described and shown (FIG. 4-FIG. 17).

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This application relates to paper clips.

2. Prior Art

Places of business, schools, homes, and anywhere paper or the like is used, people have commonly used paper clips for securing a plurality of such sheet material. Originally, paper clips were made as simple and as cheep as possible. The Gem paper clip is an example of this, having only three bends and having only one substantial plane. However, this clip lacks much capacity, and twists on even moderate amounts of sheet material. This undesirable effect leaves a consumer with weak security. Also, wire ends left to drag across areas of paper can tear documents. Thereafter, several types of paper clips were designed to have increased capacity, paper friendliness, and holding power. In 1920, U.S. Pat. No. 1,336,626 to Hall, disclosed an overlapping Ideal clip for toy construction and having an increased capacity. However, a small one is not made as a paper clip. This is because one, once deformed, is not easily re-powered. In 1936, U.S. Pat. No. 2,052,887 to Lewis, disclosed a substantially planar paper clip, not easily tangled with others. However, this clip does not work on small amounts of paper when made in even a moderately large size because no backing or overlapping is present. This is why one is made in only small sizes today.

### SUMMARY

In accordance with at least one embodiment, a paper clip of the present patent provides reversibility front side to back side with a double clipping effect enabling said clip to always have a satisfactory holding power on at least one front to back side. Pushing end portions away from a front to back side of a middle portion and bringing end portions back to an opposite front to back side of the middle portion allows for extra holding power. One document may be held with a single clipping effect and two documents may be held separately with two single clipping effects. Minimal paper dimpling, creasing, or tearing of sheet material is present, even in larger sizes due to substantial overlapping of portions. A paper clip of the present patent may be made of entirely plastic as an alternate medium.

### DRAWINGS

### Figures

FIG. 1A shows the First Embodiment broadside.

FIG. 1B shows an end view of the First Embodiment.

FIG. 1C shows a planar variation narrowing two substantial planes of end portions 16, 18 to only one substantial plane between end portions 16, 18.

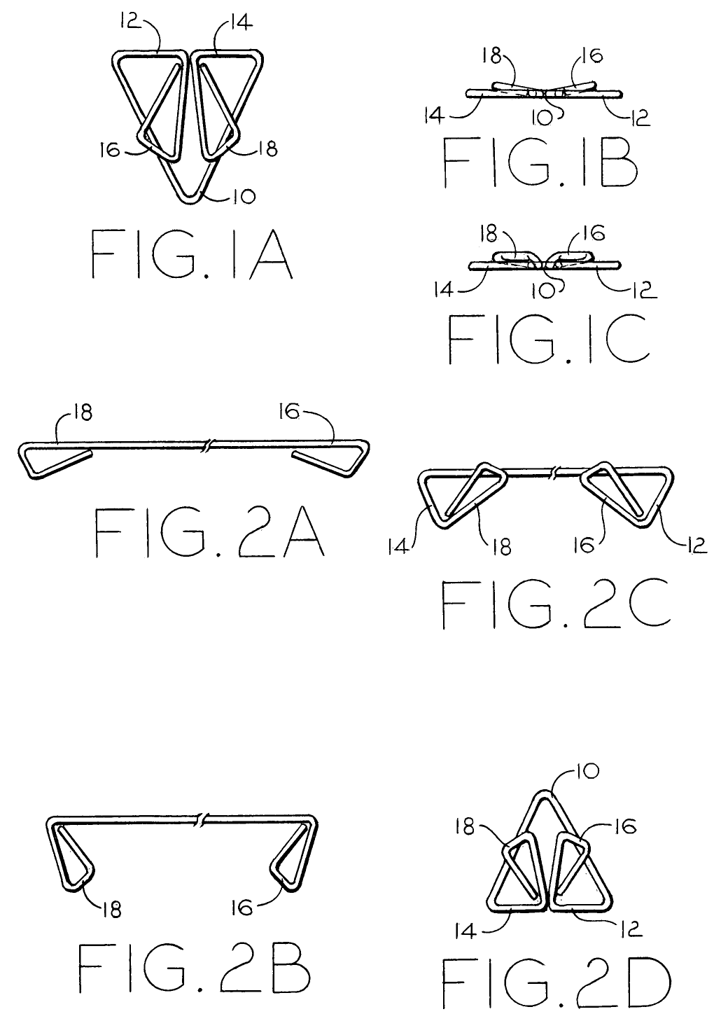

FIG. 2A shows a first step in bending end portions 16, 18.

FIG. 2B shows a second step in finishing end portion bends 16, 18

FIG. 2C shows end portions 16, 18 wedging onto, and overlapping middle portion 10.

FIG. 2D shows middle portion 10 being bent, finishing a clip.

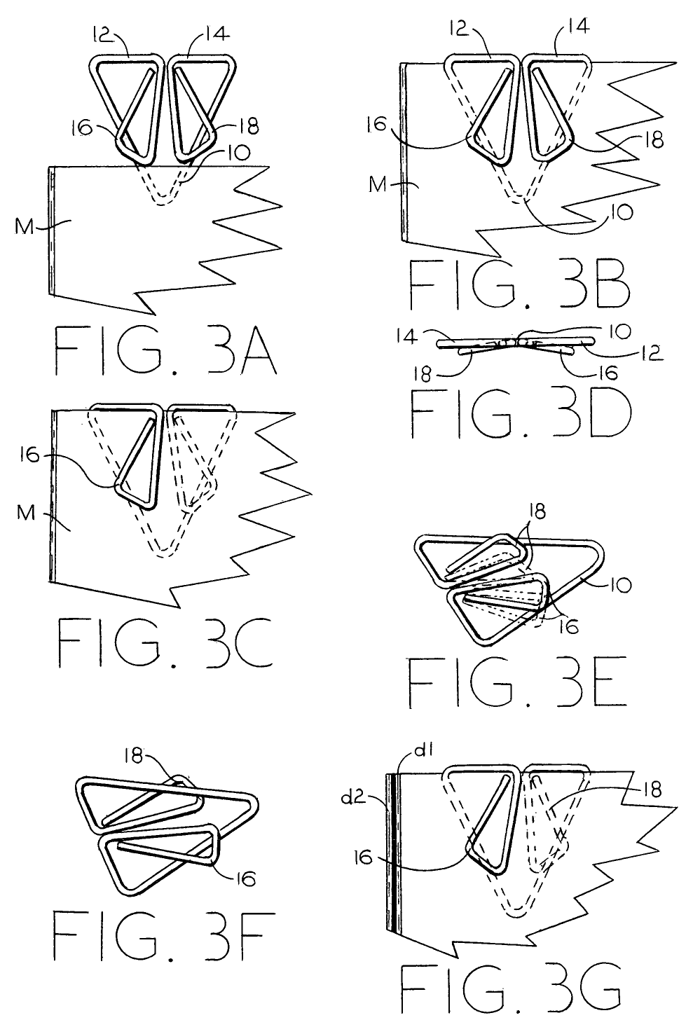

FIG. 3A shows the First Embodiment with middle portion 10 being used as a tongue to hold against one side of a sheet material M during application.

FIG. 3B shows the First Embodiment as fully applied to sheet material M.

FIG. 3C shows a single clipping effect with end portion 16 on one side of sheet material M and the rest of a clip on the other side.

FIG. 3D shows end portions 16, 18 moved to the backside of the clip.

FIG. 3E shows how a user can push end portions 16, 18 away from a side of middle portion 10 in order to bring end portions 16, 18 back to an opposite side of middle portion 10 to add extra holding power on one side of a paper clip.

FIG. 3F shows end portion 16 as moved to the backside of the clip to exemplify one end portion moved at a time.

FIG. 3G shows end portion 16 holding one sheet material on the front side of a clip, and end portion 18 holding another sheet material of the back side of the clip, separating two documents.

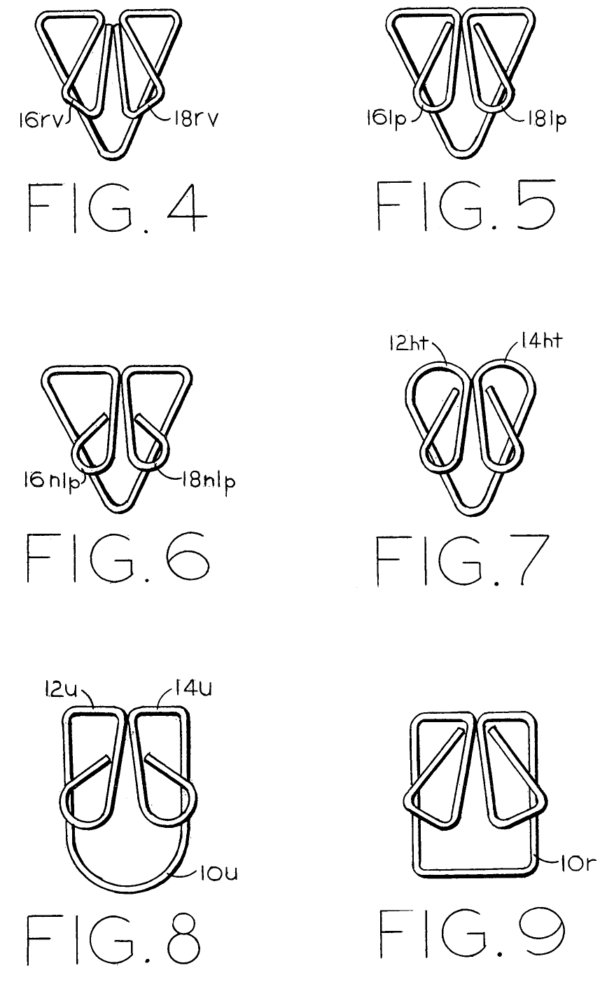

FIG. 4 shows an embodiment with end portions 16rv, 18ry running in reverse directions.

FIG. 5 shows an embodiment with end portions 161p, 181p rounding.

FIG. 6 shows an embodiment with end portion 16nlp forming a d shape and end portion 18nlp forming a b shape.

FIG. 7 shows a heart embodiment, with rounding splines 12ht, 14ht.

FIG. 8 shows a U Shape Middle Portion embodiment with splines 12u, 14u more narrow for an overall length of clip.

FIG. 9 shows a Rectangular embodiment with splines 12r, 14r more narrow for an overall size of clip as well.

FIG. 10A shows a Double Gem embodiment with end portions narrowing with lack of loop closure to U shapes.

FIG. 10B shows the Double Gem embodiment with rounded operator friendly feel as applied to a sheet material M.

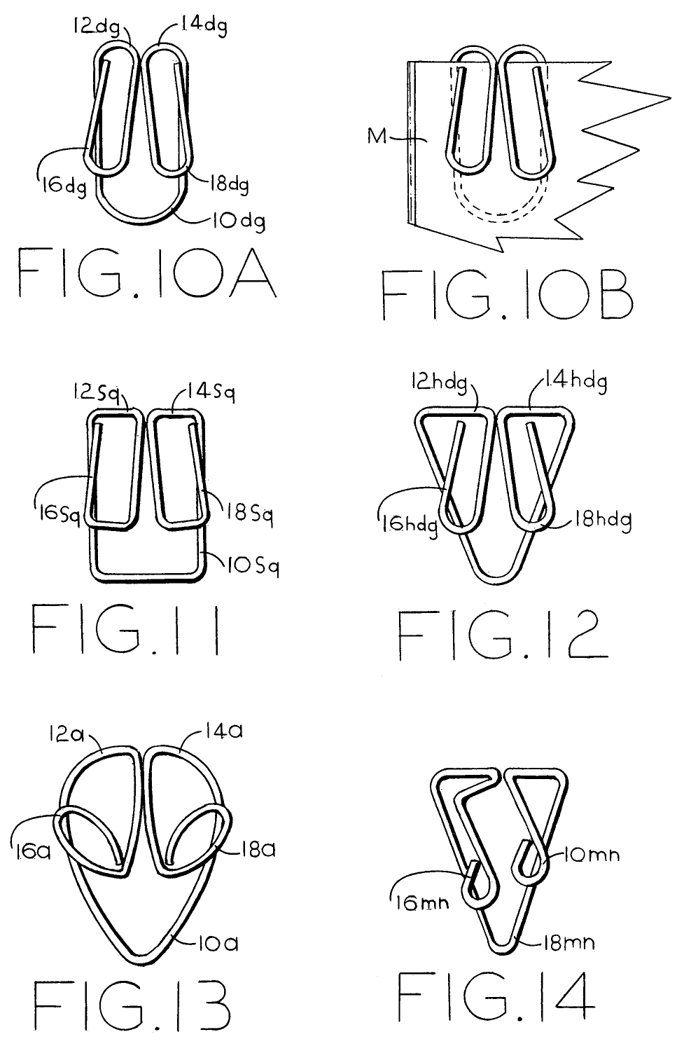

FIG. 11 shows a Squaring Double Gem embodiment.

FIG. 12 shows a Triangular Double Gem embodiment.

FIG. 13 shows an Alien embodiment for a specialized market.

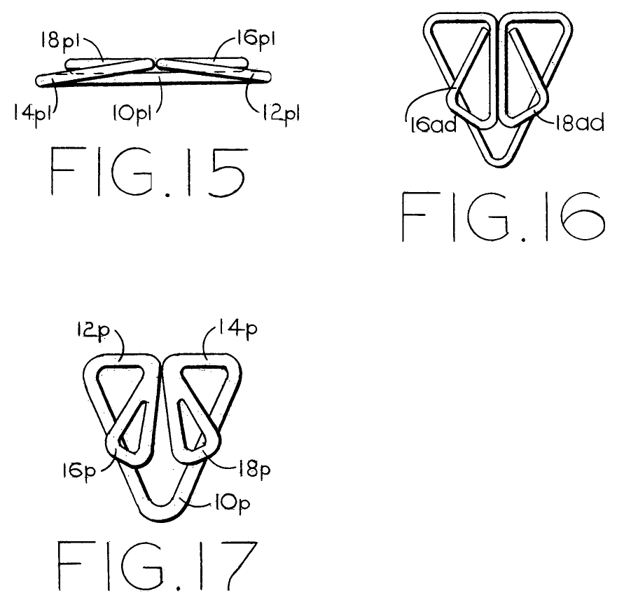

FIG. 14 shows a Music Notes embodiment for another specialized market.

FIG. 15 shows an alternate planar variation.

FIG. 16 shows an example of two end portions laterally adjacent to each other.

FIG. 17 shows an embodiment made of plastic only.

### REFERENCE NUMERALS

10 middle portion
12 spline portion
14 spline portion
16 end portion
18 end portion

The same portions are present for suffixes rv (Reverse Loop), lp (loop), nlp (Narrowing Loop), ht (Heart), u (U Shape Middle Portion), r (Rectangular), dg (Double Gem), sq (Squaring Double Gem), hdg (Triangular Double Gem), a (Alien), mn (Music Notes), pl (Two Parallel Plane), ad (Laterally Adjacent End Portion), p (Plastic Embodiment).

### DETAILED DESCRIPTION

### First Embodiment—FIG. 1A-FIG. 1C, FIG. 2A-FIG. 2D

The overall structure of this embodiment is shown in FIG. 1A with end portions 16, 18 being spaced apart laterally to form a gap, each end portion forming a triangular loop, and middle portion 10 forming a V shape. Spline portion 12 connects end portion 16 to middle portion 10, and spline portion 14 connects end portion 18 to middle portion 10 (FIG. 1A). Spine portions 12, 14 and middle portion 10 are forming a first substantial plane, end portion 16 is forming a third substantial plane, and end portion 18 is forming a third substantial plane (FIG. 1B). The substantial planes of end portions 16, 18 narrowing to one substantial plane between end portions 16, 18 is also satisfactory (FIG. 1C). Exemplary tooling is shown with the bends closest to the ends of a pre-determined length of wire metallic or composite bending first (FIG. 2A, FIG. 2B, FIG. 2C). Working from both ends of the wire strand to the center of the wire strand, end portions 16, 18 are being wedged onto middle portion 10 creating substantial overlapping (FIG. 2D). Substantial overlapping refers to enough overlapping of end portions 16, 18 on middle portion 10 to create a multiple planar embodiment of any degree differential between substantial planes of end portions 16, 18 verses the substantial plane of middle portion 10. Middle portion 10 is bending last, finishing a clip (FIG. 2D). Middle portion 10 wire length is shown broken to indicate wire length is not to scale for a finished clip. This is in order to save drafting paper space in these patent drawings. Proper wire length is determined by measurements of a drawing such as FIG. 1A or the use of string being laid down on such a drawing. Overall size to wire diameter ratio of a clip is generally about one and one-half inch across spline portions 12, 14 or longer by about one and one-half inch or longer for a wire diameter of one sixteenth of an inch. Any overall size fit for human hands is satisfactory. This specification is for standard chrome paper clip wire. Wire diameters will vary depending on a wire rigidity or an amount of wire spring quality.

### Operation—First Embodiment, FIG. 3A-FIG. 3G

The longitudinal end of middle portion 10 opposite splines 12, 14 is used as a tongue and being applied to a side of sheet material M, end portions 16, 18 are urged to the other side of sheet material M with a finger or the like (FIG. 3A). Spline portions 12, 14 are providing communication between end portions 16, 18 and middle portion 10 respectively (FIG. 3B). Sliding into place, spline portions 12, 14 come to an edge of sheet material M providing a primary double clipping effect (FIG. 3B). End portions 16, 18 being spaced apart laterally to form a gap facilitates operator movement of end portions 16, 18 to an opposite front to back side of this embodiment. Only one end portion, for example, end portion 16, may be urged to a side of sheet material M, and a single clipping effect is present (FIG. 3C). Each of end portions 16, 18 may be moved to an opposite front to back side of a clip by an operator to find a satisfactory holding front to back side of a paper clip if weak holding power is present on a front or back side of a clip from deformation (FIG. 3D). Each of end portions 16, 18 may be pushed away from middle portion 10 and brought back to an opposite front to back side of middle portion 10 to create extra holding power (FIG. 3E). Only one end portion, for example end portion 18, may be moved to an opposite front to back side of middle portion 10 with end portion 16 left on the first side of middle portion 10. Now, one document d1 may be held with end portion 16 on the first side of a clip, and another document d2 may be held with end portion 18 on the back side of a clip. This feature is providing a single clipping effect and providing ability for separate clipping of two documents with two single clipping effects (FIG. 3F, FIG. 3G).

### Reverse Loop—FIG. 4

End portions 16rv, 18ry are running in reverse directions (FIG. 4).

### Operation—Reverse Loop Embodiment, FIG. 1B, FIG. 3A-FIG. 3G

This Reverse Loop embodiment operates the same as the First embodiment (FIG. 1B, FIG. 3A-FIG. 3G.

### Simple Loop—FIG. 5

End portions 161p, 181p are rounding (FIG. 5).

### Operation—Simple Loop Embodiment, FIG. 1B, FIG. 3A-FIG. 3G

Operation of this Simple Loop embodiment is the same as the First embodiment (FIG. 1B, FIG. 3A-FIG. 3G.

### A Narrowing Loop Embodiment—FIG. 6

End portion 16nlp loop size is narrowing to form a d shape, and end portion 18nlp loop size is narrowing to form a b shape (FIG. 6).

Operation—Narrowing Loop embodiment, FIG. 1B, FIG. 3A-3G

Operation of this Narrowing Loop embodiment is the same as the First embodiment (FIG. 1B, FIG. 3A-FIG. 3G).

### Heart—FIG. 7

Spline portions 12ht, 14ht are rounding. An overall heart shape is being made (FIG. 7).

### Operation—Heart Embodiment, FIG. 7, FIG. 1B, FIG. 3A-3G

Operation of this Heart embodiment is the same as the First embodiment, but with slightly narrowing capacity due to rounding spline portions 12ht, 14ht (FIG. 7, FIG. 1B, FIG. 3A-FIG. 3G).

### U Shape Middle Portion—FIG. 8

This embodiment is narrowing in sheet material capacity, for a given overall length in comparison to the First Embodiment. This narrowing capacity is due to middle portion 10u forming a U shape (FIG. 1A, FIG. 8). End portions are, but not necessarily, d and b shape (FIG. 8).

### Operation—U Shape Middle Portion Embodiment, FIG. 1B, FIG. 3A-3G

Operation of this U Shape Middle Portion embodiment is the same as the First Embodiment (FIG. 1B, FIG. 3A-3G).

### Rectangular—FIG. 9

This embodiment is a little longer overall, when comparing to the First Embodiment, if both embodiments are having the same width across spline portions. Middle portion 10r forms a squaring U shape. End portions are, but not necessarily, triangular loops (FIG. 9).

### Operation—Rectangular, FIG. 1B, FIG. 3A-3G

Operation of this Rectangular embodiment is the same as the First embodiment (FIG. 1B, FIG. 3A-FIG. 3G).

### Double Gem—FIG. 10a

End portions 16dg, 18dg are narrowing to lack of loop closure with U shapes. This embodiment is narrowing in capacity for a given length by middle portion 10dg forming a U shape. Spline portions 12dg, 14dg are, but not necessarily, rounding (FIG. 10A).

### Operation—Double Gem Embodiment, FIG. 1B, FIG. 3A-FIG. 3G, FIG. 10B

Operation of this Double Gem embodiment is the same as the First Embodiment (FIG. 1B, FIG. 3A-FIG. 3G). When applied in a primary clipping effect, this embodiment looks like two classic Gem style paper clips, side by side, on sheet material M (FIG. 10B).

### Squaring Double Gem—FIG. 11

U shape end portions 16sq, 18sq are squaring. Middle portion 10sq is a squaring U shape. This embodiment is slightly longer overall, for a given spline length of 12sq, 14sq as compared to spline length of 12, 14 of the First Embodiment.

### Operation—Squaring Double Gem Embodiment—FIG. 1B, FIG. 3A-FIG. 3G

This Squaring Double Gem embodiment operates the same as the First Embodiment (FIG. 1B, FIG. 3A-FIG. 3G).

### Triangular Double Gem—FIG. 12

This embodiment is a Double Gem embodiment with the sheet material capacity of the First Embodiment. End portions 16hdg, 18hdg are narrowing to lack of loop closure to U shapes which look like two standard Gem paper clips, side by side, on sheet material.

### Operation—Triangular Double Gem, FIG. 1B, FIG. 3A-FIG. 3G

This embodiment operates the same as the First Embodiment (FIG. 1B, FIG. 3A-FIG. 3G)

### Alien—FIG. 13

End portions 16a, 18b are narrowing in loop size to form an overall depiction of an alien. Middle portion 10a is forming a rounding V shape. Spline portions 12a, 14a are rounding.

### Operation—Alien Embodiment, FIG. 1B, FIG. 3A-FIG. 3G

This Alien embodiment operates the same as the First Embodiment, but with narrowing sheet material capacity due to rounding splines.

### Music Notes—FIG. 14

This embodiment has end portions 16nm, 18 nm narrowing in loop size by together forming a symbol of music notes. Middle portion 10nm is slightly more narrow than the First Embodiment with narrowing sheet material capacity.

Operation—Music notes, FIG. 1B, FIG. 3A-FIG. 3G

This Music Notes embodiment operates the same as the First Embodiment (FIG. 1B, FIG. 3A-FIG. 3G).

### Two Parallel Plane Example—FIG. 15

This end view is exemplary of two end portions 16pl, 18pl forming a substantially parallel plane with a middle portion 10 pl substantial plane. Spline portions 12pl, 14 pl connect middle portion 10 pl to end portions 16pl, 18pl, respectfully.

### Operation—FIG. 3A-FIG. 3C, FIG. 3E-FIG. 3G

This type of embodiment functions the same as the first embodiment. However, this type of construction is narrowing to one front to back side of a clip operable (FIG. 3A-FIG. 3C, FIG. 3E-FIG. 3G).

### Detailed Description—Laterally Adjacent End Portion Example—FIG. 16

This illustration is exemplary of how two end portions 16ad, 18ad laterally adjacent to each other, and contiguous with each other is also satisfactory (FIG. 16).

### Operation—Laterally Adjacent End Portion Example (FIG. 1B, FIG. 3A-FIG. 3G)

This type of embodiment functions the same as the First Embodiment. However, in this type of construction, a first end portion to be moved to an opposite front to back side of a clip, needs to be placed on the underside of the other end portion to avoid hang up. Under, not over the other end portion is the only thing needed to see when moving a first end portion. This type of construction is also satisfactory.

### Plastic Embodiment Example (FIG. 17)

This illustration is showing how an embodiment may be made of plastic, most likely being molded. All portions 10p, 12p, 14p, 16p, 18p are for seen as flattened. At present see an embodiment such as this one being one sixteenth of an inch thick or less for an overall clip size of one and one half inch by one and one half inch. Thicknesses of plastic will vary depending on plastic rigidity.

### Operation—Plastic Embodiment Example (FIG. 1B, FIG. 3A-FIG. 3G)

This type of material will also be satisfactory. Plastic embodiments may hold lighter, depending on thickness and rigidity of plastic.

### Advantages

Advantages of the present paper clip include strong hold down to a single sheet of paper or like sheet material with minimal paper dimpling, creasing, or tearing. Another advantage is one not tangling with other clips in a box. Another functional advantage of the present paper clip is being the only overlapping paper clip reversible front side to back side, enabling a user to find a strong holding side regardless of prior usage to provide a long life of the clip. Yet another advantage is an ability to make embodiments in any size, and always having one hold strong down to a single sheet of paper or like sheet material, due to an overlapping double clipping effect. Finally, the ability to hold two documents separately, one front side and one back side, is complimentary.

### CONCLUSION, RAMIFICATION, SCOPE

Uses for the present paper clip technology include bag closure, securing mail packets, book marking, money clipping, etc. Wire sheath in various colors made of plastic, vinyl, or other material known to the industry is applicable. Metallic gold finish, chrome, or other wire metallic or composite is also satisfactory. Painting of wire is applicable. Construction of plastic molded paper clips in various colors may be implemented instead of wire metallic or composite. Overall sizes for the First Embodiment may be as small as about half of an inch wide by five eighths of an inch long, as big a three inches wide by three and a half inches long and every size in between. Other embodiments are of similar size ranges.

Thus the reader will see that at least one embodiment of the present patent provides a more paper friendly, more versatile, more powerful, yet economical device able to be used by persons of almost any age. While my above description contains much specificity, this should not be construed as limiting the scope of the embodiment but rather as merely providing illustrations of some of the presently preferred embodiments. For example, other embodiments of combinations of portions and parts are also satisfactory. End portions may be spirals instead of loops. An overall shape may be circular, square, oval, trapezoidal, etc. Other symbols besides music notes may be constructed. An animal head instead of an alien will also be satisfactory, cartoon character, etc.

Thus the scope of the embodiment should be determined by the appended claims and their legal equivalents, rather than by the examples given.

1. A paper clip being formed of a pre-determined length of wire metallic or composite, wherein the improvement comprises a multiple planar paper clip with two end portions reversible front side to back side of a middle portion, providing a primary double clipping effect, having each of said end portions substantially overlapping said middle portion, each of two spline portions connecting each of said end portions with said middle portion, an end of said middle portion protruding as a tongue to hold against one side of at least one sheet of paper or like sheet material upon application, said end portions urging to the other side of said at least one sheet of paper or like sheet material with a finger or the like, and having said spline portions providing communication between said middle portion and said end portions respectively, providing said primary double clipping effect.

2-10. (canceled)

11. The paper clip of claim 1 wherein said end portions are being spaced apart laterally to form a gap to facilitate operator movement of end portions to an opposite front to back side of said paper clip.

12. The paper clip of claim 11 wherein said gap is narrowing in as much as end portions being laterally adjacent and contiguous with each other.

13. (canceled)

14. The paper clip of claim 1 wherein said middle portion and said spine portions are comprising a first substantial plane, one of said end portions is comprising another substantial plane, and the other of said end portions is comprising a third substantial plane.

15. The paper clip of claim 14 wherein the substantial planes of said end portions are narrowing to one substantial plane between said end portions.

16. The paper clip of claim 1 wherein said front to back reversibility is narrowing to one front to back side of said middle portion favorable to application to said paper or like sheet material by having both of said end portions in a one substantial plane parallel with said middle portion plane and spline portions connecting portions of the two parallel substantial planes.

17. The paper clip of claim 1 wherein said spline portions are straight.

18. The paper clip of claim 17 wherein said paper or like sheet material capacity for a given width of said paper clip is narrowing by rounding said spine portions.

19. A paper clip being formed of a pre-determined length of wire metallic or composite, wherein the improvement comprises a multiple planar paper clip with two end portions reversible front side to back side of a V shape middle portion, providing a primary double clipping effect, having each of said end portions forming a loop substantially overlapping said V shape middle portion, each of two spline portions connecting each of said end portions with said V shape middle portion, an end of said V shape middle portion protruding as a tongue to hold against one side of at least one sheet of paper or like sheet material upon application, said end portions urging to the other side of said at least one sheet of paper or like sheet material with a forger or the like, and having said spline portions providing communication between said V shape middle portion and said end portions respectively, providing said primary double clipping effect.

20. The paper clip of claim 19 wherein one of said end portions is narrowing in loop size to form a d shape and the other one of said end portions is narrowing in loop size to form a b shape.

21. The paper clip of claim 20 wherein each of said end portions are further narrowing with lack of loop closure to a U shape.

22. The paper clip of claim 19 wherein said V shape middle portion is narrowing in said paper or like sheet material capacity, for a given longitudinal length of said paper clip by lateral width across said end portions each forming a loop, by forming a U shape.

23. The paper clip of claim 22 wherein one of said end portions is narrowing in loop size to form a d shape and the other one of said end portions is narrowing in loop size to form a b shape.

24. The paper clip of claim 23 wherein each of said end portions are further narrowing with lack of loop closure to a U shape.

25. The paper clip of claim 19 wherein each of said end portions are narrowing in loop size to form a symbol together.

26. The paper clip of claim 19 wherein each of said end portions are narrowing in loop size to form an overall alien depiction.

27. The paper clip of claim 19 wherein said front to back reversibility is narrowing to one front to back side of said middle portion favorable to application to said paper or like sheet material by having both of said end portion loops in a one substantial plane parallel with said V shape middle portion plane and spline portions connecting portions of the two parallel substantial planes.

28. The paper clip of claim 27 wherein one of said end portions is narrowing in loop size to form a d shape and the other one of said end portions is narrowing in loop size to form a b shape.

29. The paper clip of claim 28 wherein each of said end portions are further narrowing with lack of loop closure to a U shape.

30. A method of clipping sheet material, comprising:
(a) providing a paper clip being formed of wire metallic or composite, wherein the improvement comprises a multiple planar paper clip with two end portions reversible front side to back side of a middle portion, providing a primary double clipping effect, having each of said end portions substantially overlapping said middle portion, each of two spline portions connecting each of said end portions with said middle portion, an end of said middle portion protruding as a tongue to hold against one side of at least one sheet of paper or like sheet material upon application, said end portions urging to the other side of the sheet material with a finger or the like, and having said spline portions providing communication between said middle portion and said end portions, respectively, providing said primary double clipping effect,
(b) having means for said end portions to be moved by an operator to an opposite front to back side of said middle portion is enabling said operator to have at least one satisfactory holding front to back side of overlapping said paper clip,
(c) having means to push away said end portions from said middle portion, and to bring back said end portions to an opposite front to back side of said middle portion is to add more holding power,
(d) having means for one of said end portions to be moved to an opposite front to back side of said middle portion, and the other one of said end portions left on the first front to back side of said middle portion to in order to utilize a single clipping effect or to accommodate separate clipping of two documents with two single clipping effects,
whereby a human can work, read, travel, and enjoy secured papers or the like.
